(19) United States
(12) Patent Application Publication
(10) Pub. No.: US 2026/0180013 A1
(43) Pub. Date: Jun. 25, 2026

(54) Current Collector for a Battery with an Electrode Winding

(71) Applicant: Bayerische Motoren Werke Aktiengesellschaft, Muenchen (DE)

(72) Inventors: Manfred RAPP, Forstinning (DE); Hyunchul ROH, Muenchen (DE); Nina ZENSEN, Pfaffenhofen an der Ilm (DE)

(21) Appl. No.: 19/125,522

(22) PCT Filed: Oct. 24, 2023
(86) PCT No.: PCT/EP2023/079591

§ 371 Date: Apr. 29, 2025

(30) Foreign Application Priority Data
Oct. 31, 2022 (DE) 10 2022 128 837.4

(51) Int. Cl. H01M 10/0525; H01M 4/66

(52) U.S. Cl. CPC H01M 10/0525; H01M 4/661

(57) ABSTRACT

A current collector for a battery with an electrode winding, wherein electrode lugs project from the electrode winding and form an end-face contact surface of the electrode winding, the current collector having a first contacting element and at least one second contacting element, wherein the first contacting element and the second contacting element are electrically conductive, are electrically connected to one another, are displaceable with respect to one another in order to be adapted to the shape of the contact surface, and are designed to be electrically connected to the contact surface.

### BACKGROUND AND SUMMARY

The present disclosure relates to a current collector for a battery with an electrode winding.

Electrode windings are primarily used in round cells and prismatic cells and are intended to permit the highest possible energy density of the battery. The electrode winding has one or more layers, each layer having a cathode, an anode and a separator. The cathodes and the anodes can be contacted electrically via electrode lugs. The electrode lugs of all the cathodes of the electrode winding are led out at one end face, and the electrode lugs of the anodes of the electrode winding are led out at the other end face of the electrode winding. The anode is connected to the positive terminal and the cathode is connected to the negative terminal of the battery, each via a current collector.

In the production process of the battery, during the winding of the electrode winding it can occur that the layers are not located exactly congruently above one another and, as a result, no flat end face of the electrode winding results. The cause may be found, for example, in non-uniformly large layers and in the winding process or in the quality of the fabricated electrode tracks. The curvature of the end face of the electrode winding after the winding is also influenced by the materials used, the loading of the electrodes and the calendering pressure. In particular as a result of the attempts to increase the energy density in lithium-ion cells, the loading of the electrodes and the calendering pressure is increased, as a result of which a more intense curvature, also designated as “camber” in technical language, of the end face of the electrode winding occurs. Here, both specification-typical curvature influences and, additionally for each electrode winding, individual curvature influences occur.

In the production process, the current collectors are placed on the end faces of the electrode winding and connected to one another via a welding operation. In order to ensure a good electrical connection between the electrode lugs and the current collectors, the current collectors must already be in good contact with all the electrode lugs before the welding. Otherwise, the welding operation becomes more difficult.

The curvature of the electrode winding makes it more difficult to contact the electrode lugs of the electrode winding at the end face and to weld the current collector to the electrode lugs. At the present time, current collectors are designed to be flat or have a predefined, in particular convex, curvature.

An object of the present disclosure is to ensure simple and reliable electric contact between the current collectors and the electrode lugs for each individual electrode winding, even when there are uneven end faces of the electrode windings.

This object is achieved by a current collector as disclosed herein. The present disclosure also shows preferred developments.

The current collector is suitable for use in a battery having an electrode winding. Electrode lugs project from the electrode winding and form an end-face contact surface of the electrode winding. The current collector has a first contacting element and at least one second contacting element. The first contacting element and the second contacting element are electrically conductive and electrically connected to one another. The first contacting element and the second contacting element are displaceable with respect to one another in order to be adapted to the shape of the contact surface and are designed to be electrically connected to the contact surface.

As a result of the displaceability of the first contacting element and of the second contacting element with respect to one another, both a flat shape and also a shape of the contact surface that deviates therefrom can be approached better than with a merely flat current collector. Likewise, as a result of the displaceability, it may be possible to make better contact between the first contacting element and the second contacting element and the contact surface of the individual electrode winding than by a contacting element having a fixedly predefined, for example, convexly curved, shape. As a result of the better and individual adaptation of the current collector to the curvature of the end face of each individual electrode winding, the electrode lugs can be contacted better at the end face. As a result, even in the event of a curved end face, simple welding between the electrode lugs and the current collector with an additionally good electrical contact between the electrode lugs and the current collector is possible.

As a result of the electrical connection between the first contacting element and the second contacting element, it is sufficient to produce an electrical contact with a battery terminal at only one of the two contacting elements. This simplifies the production of the battery.

Advantageously, the first contacting element and the second contacting element are connected to one another via a force-fitting connection. Here, the force-fitting connection applies at least a predefined clamping force between the first contacting element and the second contacting element.

By the simple action of force, force-fitting connections permit displacement of the first contacting element and the second contacting element with respect to one another without any further effort for releasing the connection. In addition, the force-fitting connection locks the relative position of the first contacting element with respect to the second contacting element as soon as the external action of force ceases, without needing any further effort for the locking. Thus, a simple method for the displacement and locking of the first contacting element to the second contacting element is provided by the force-fitting connection. By the preloading force, in particular unintended displacement of the first contacting element with respect to the second contacting element as a result of handling the current collector, as is usual in the production, is prevented. This simplifies the handling of the current collector.

Preferably, the first contacting element at least partly encloses the second contacting element or the second contacting element at least partly encloses the first contacting element. The enclosing action simplifies the provision of a force-fitting connection between the first contacting element and the second contacting element. In addition, the enclosing action permits a particularly compact design of the current collector.

Particularly preferably, the first contacting element encloses the second contacting element or the second contacting element encloses the first contacting element in at least one plane. This enables guidance and displacement of the second contacting element with respect to the first contacting element or of the first contacting element with respect to the second contacting element in the direction of a normal to the plane.

Advantageously, the first contacting element and the second contacting element have the same shape. Here, a first circumference of the first contacting element is larger than a second circumference of the second contacting element, or the second circumference is larger than the first circumference. This facilitates an arrangement in which the first contacting element at least partly encloses the second contacting element or the first contacting element at least partly encloses the second contacting element.

Particularly advantageously, the first contacting element and the second contacting element have the cross-sectional shape of the electrode winding. As a result, the first contacting element and the second contacting element cover the contact surface completely without protruding beyond the circumference of the electrode winding. This enables a particularly compact arrangement of the current collector in the battery.

Preferably, the first contacting element and the second contacting element are arranged concentrically. This enables an axially symmetrical displacement of the first contacting element and of the second contacting element with respect to one another. Since the electrode windings, as are used in round cells or prismatic cells, for example, are axially symmetrical, a concentric arrangement of the first contacting element and of the second contacting element enables particularly good electrical contact of the current collector with the electrode lugs of the electrode winding.

In an alternative embodiment, the first contacting element and the second contacting element are arranged beside one another. The side-by-side arrangement makes it possible for the first contacting element and the second contacting element to have an identical shape. Thus, the production complexity and the production outlay of the current collector can be reduced. Here, a force-fitting connection between the first contacting element and the second contacting element can also be implemented, with the aforementioned advantages.

Preferably, the first contacting element is guided in at least a second groove of the second contacting element and/or the second contacting element is guided in at least a first groove of the first contacting element. By the guidance, a direction of the relative movement of the first contacting element with respect to the second contacting element is predefined. In addition, a force-fitting connection can be implemented via the first groove and/or the second groove.

Particularly preferably, the first groove and/or the second groove are configured as an undercut. This gives the first groove and/or the second groove the property of preventing a relative movement between the first contacting element and the second contacting element in a different direction than a longitudinal direction of the first groove and/or the second groove. This facilitates the handling of the current collector without reducing the capability of adapting the current collector to the curvature of the contact surface.

The displacement of the first contacting element and the second contacting element is possible before the contacting of the current collector with the contact surface of the electrode winding. To this end, the contact surface is scanned and the curvature of the contact surface is determined. The first contacting element and the second contacting element are then displaced with respect to one another in a way corresponding to the determined curvature of the contact surface.

Advantageously, the first contacting element and the second contacting element are displaceable with respect to one another and adaptable to the contact surface by pressing onto the contact surface. Accordingly, it is possible to dispense with scanning the contact surface and presetting the displacement of the first contact element with respect to the second contact element. This property of the first contacting element and the second contacting element is achieved by an appropriately set force-fitting connection. In particular, the force needed to overcome the force-fitting connection lies below a force and/or corresponds to this force which the electrode lugs withstand without breaking off.

Particularly advantageously, a force-fitting connection between the first contacting element and the second contacting element is achieved by surface friction between the first contacting element and the second contacting element. With this implementation of a force-fitting connection, no further elements are needed in the current collector. As a result of which, the production complexity and the production costs are reduced.

Preferably, friction between the first contacting element and the second contacting element can be implemented by at least two, in particular three, points of contact between the surface of the first contacting element and the surface of the second contacting element. Thus, only these two, in particular three, points of contact have to be produced dimensionally accurately. The remaining surface of the first contacting element and of the second contacting element do not have to correspond to this high dimensional accuracy and do not have to be in contact with the respective other surface. In the embodiment having the grooves in the first contacting element and/or the second contacting element, the grooves and the corresponding fit of the respective other contacting element engaging in the groove are already to be understood as points of contact. In this exemplary embodiment, the two contacting points relate to the groove and the corresponding fit.

Particularly preferably, the current collector has a multiplicity of second contacting elements. In particular, the second contacting elements are electrically connected to one another and each displaceable with respect to one another. This makes it possible to sense a curvature of the contact surface by a plurality of contacting elements and to better adapt to the contact surface.

Advantageously, the electrical connection between the first contacting element and the second contacting element can be made directly between the first contacting element and the second contacting element by direct contact of the surfaces of the first contacting element and of the second contacting element. This reduces the number of elements needed in the current collector and reduces the production costs of the current collector.

Alternatively or additionally, the current collector has a connecting element. The connecting element is electrically connected to the first contacting element and the second contacting element. The connecting element permits a greater degree of design freedom of the first contacting element and the second contacting element, since these do not have to be electrically conductive at their point of contact.

Preferably, the connecting element is designed to contact a terminal of the battery directly. Thus, the current collector permits a reduction in the number of components of the battery.

Furthermore, the present disclosure comprises a battery element having an electrode winding. Electrode lugs project out of the electrode winding and form an end-face contact surface of the electrode winding. The battery element comprises a current collector according to one of the preceding embodiments, wherein the first contacting element of the current collector and the second contacting element of the current collector are adapted to the contact surface and at least partly electrically connected to the contact surface. Such a battery element has better contact between the current collector and the electrode winding and permits simpler production.

Preferably, the battery element has an integral connection, in particular a welded collection, between the first contacting element and/or the second contacting element and the contact surface. An integral connection enables a particularly low electrical resistance between the electrode lugs and the first contacting element and the second contacting element. A welded collection, in particular a welded connection created by laser welding, needs no direct mechanical intervention in the battery cell and accelerates the production of the battery cell.

Particularly preferably, the first contacting element and the second contacting element are at least partly fastened to one another by the integral connection. Here, the integral connection between the first contacting element and the second contacting element opposes a greater force to a displacement between the first contacting element and the second contacting element than the force-fitting connection.

After an integral connection, a simple displacement is no longer readily possible. However, this is desired, since the integral connection between the first contacting element and the second contacting element is made only after the first contacting element and the second contacting element are adapted to the contact surface. Unintended displacement between the first contacting element and the second contacting element is prevented. Thus, an integral connection between the first contacting element and the second contacting element ensures an electrical connection between the contact surface and the first contacting element and the second contacting element even under the action of higher external forces on the battery, as occur, for example, in the event of impacts.

Further details, features and advantages of the present disclosure can be gathered from the following description and the figures.

### BRIEF DESCRIPTION OF THE DRAWINGS

FIG. 1 shows a schematic illustration of a battery having an electrode winding and a current collector according to the prior art,

FIG. 2 shows a schematic illustration of a cross section of a current collector according to a first exemplary embodiment of the present disclosure,

FIG. 3 shows a schematic illustration of a cross section of a current collector according to a second exemplary embodiment of the present disclosure, and

FIG. 4 shows a schematic illustration of a battery having a current collector according to a third exemplary embodiment of the present disclosure.

### DETAILED DESCRIPTION OF THE DRAWINGS

FIG. 1 shows a schematic illustration of a battery 1 having an electrode winding 5 and a current collector 7 according to the prior art.

The electrode winding 5 has electrode lugs 5a, 5b, which project at both end faces of the electrode winding 5 and each form a contact surface 6a, 6b. First electrode lugs 5a of the anode are located on one end face of the electrode winding 5, and second electrode lugs 5b of the cathode are located on the other end face of the electrode winding 5. In the illustration in FIG. 1, the second electrode lugs 5b of the cathode are located on the lower end face of the electrode winding 5 and form a cathode-side contact surface 6b. In the illustration in FIG. 1, the first electrode lugs 5a of the anode are located on the upper end face of the electrode winding 5 and form an anode-side contact surface 6a. The electrode winding 5 is not uniform and therefore has curved contact surfaces 6a, 6b.

A negative terminal 3 of the battery 1 forms the housing of the battery 1. The positive terminal 2 of the battery 1 is arranged at one end of the battery and electrically insulated from the negative terminal 3 by a seal 4, and projects beyond the housing of the battery 1 to make contact. The cathode-side contact surface 6b is connected to the housing and thus to the negative terminal 3 of the battery 1 via a current collector 7. The anode-side contact surface 6a is connected to the positive terminal 2 of the battery 1 via a current collector 7 and a connecting spring 8.

The current collectors 7 according to the prior art are flat. Consequently, the current collector 7 cannot follow the curvature of the contact surfaces 6a, 6b, and not all the electrode lugs 5a, 5b are contacted. In order nevertheless to contact all the electrode lugs 5a, 5b, the current collector 7 must be pressed further against the contact surface 6a, 6b, the electrode lugs 5a, 5b are hereby displaced. This makes subsequent welding of the electrode lugs 5a, 5b to the current collectors 7 more difficult. The same problem results in current collectors 7 having a predefined, in particular convex, curvature of the current collectors 7.

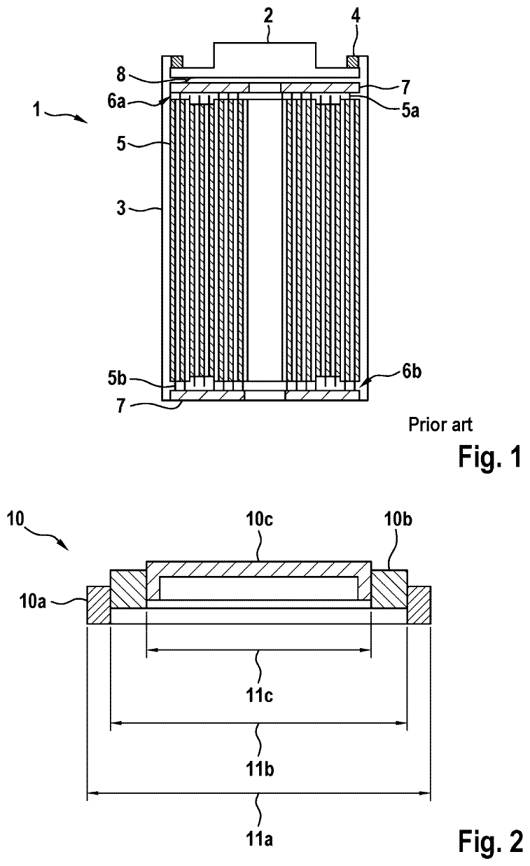

FIG. 2 shows a schematic illustration of a cross section of a current collector 10 according to a first exemplary embodiment of the present disclosure.

The current collector 10 is suitable for use in the battery 1 having the electrode winding 5. Here, as previously explained in relation to the prior art, electrode lugs 5a, 5b protrude out of the electrode winding 5 and form the end-face contact surface 6a, 6b of the electrode winding 5. The current collector 10 has a first contacting element 10a and at least one second contacting element 10b, 10c. The first contacting element 10a and the second contacting element 10b, 10c are electrically conductive and electrically connected to one another. The first contacting element 10a and the second contacting element 10b, 10c are displaceable with respect to one another in order to be adapted to the shape of the contact surface 6a, 6b, and are designed to be electrically connected to the contact surface 6a, 6b.

As a result of the displaceability of the first contacting element 10a and the second contacting element 10b, 10c with respect to one another, both a flat shape but also a shape of the contact surface 6a, 6b deviating therefrom can be approached better than with a merely flat current collector 10. Likewise, as a result of the displaceability, a contact between the first contacting element 10a and the second contacting element 10b, 10c can be adapted better to the contact surface 6a, 6b of the individual contacting winding 5 than by a current collector 7 according to the prior art having a fixedly predefined, for example a convexly curved, shape. As a result of the better and individual adaptation of the current collector 10 to the curvature of the contact surface 6a, 6b of each individual electrode winding 5, the electrode lugs 5a, 5b can be contacted better on the contact surface 6a, 6b. As a result, even with a curved contact surface 6a, 6b, simple welding between the electrode lugs 5a, 5b and the current collector 10 is possible with a still good electrical contact between the electrode lugs 5a, 5b and the current collector 10.

As a result of the electrical connection between the first contacting element 10a and the second contacting element 10b, 10c, it is sufficient to produce an electrical contact with a terminal 2, 3 of the battery 1 on only one of the two contacting elements 10a, 10b, 10c. This simplifies the production of the battery 1.

Preferably, the current collector 10 has a multiplicity of second contacting elements 10b, 10c. In particular, the second contacting elements 10b, 10c are electrically connected to one another and each displaceable with respect to one another. An exemplary embodiment relating to this is shown in FIG. 2. Therein, the second contacting element 10b is at least partly enclosed by the first contacting element 10a, and a further, second contacting element 10c is at least partly enclosed by the second contacting element 10b. This makes it possible for a curvature of the contact surface 6a, 6b to be sensed by a plurality of contacting elements 10a, 10b, 10c and to be adapted better to the contact surface 6a, 6b.

Advantageously, the first contacting element 10a and the second contacting element 10b, 10c are connected to one another via a force-fitting connection. Here, the force-fitting connection applies at least a predefined clamping force between the first contacting element 10a and the second contacting element 10b, 10c.

By the simple action of force, force-fitting connections permit displacement of the first contacting element 10a and the second contacting element 10b, 10c with respect to one another without any further effort for releasing the connection. In addition, the force-fitting connection locks the relative position of the first contacting element 10a with respect to the second contacting element 10b, 10c as soon as the external action of force ceases, without needing any further effort for the locking. Thus, a simple method for the displacement and locking of the first contacting element 10a to the second contacting element 10b, 10c is provided by the force-fitting connection. By the preloading force, an unintended displacement of the first contacting element 10a with respect to the second contacting element 10b, 10c by handling the current collector 10, as is usual in the production, is prevented. This simplifies handling of the current collector 10.

Preferably, the first contacting element 10a at least partly encloses the second contacting element 10b, 10c, or the second contacting element 10b, 10c at least partly encloses the first contacting element 10a. The enclosing action simplifies the provision of a force-fitting connection between the first contacting element 10a and the second contacting element 10b, 10c. In addition, the enclosing action permits a particularly compact design of the current collector 10.

Particularly preferably, the first contacting element 10a encloses the second contacting element 10b, 10c or the second contacting element 10b, 10c encloses the first contacting element 10a in at least one plane. This enables guidance and displacement of the second contacting element 10b, 10c with respect to the first contacting element 10a or of the first contacting element 10a with respect to the second contacting element 10b, 10c in the direction of a normal to the plane.

As can be gathered from the exemplary embodiment of FIG. 2, the further second contacting element 10c is at least partly enclosed by the second contacting element 10b. The further second contacting element 10c and the second contacting element 10b have a fit such that the further second contacting element 10c is held in the second contacting element 10b by friction. The second contacting element 10b is partly enclosed by the first contacting element 10a, and the second contacting elements 10b and the first contacting element 10a have a fit such that the second contacting element 10b is held in the first contacting element 10a by friction.

Advantageously, the first contacting element 10a and the second contacting element 10b, 10c have the same shape. Here, a first circumference 11a of the first contacting element 10a is larger than a second circumference 11b, 11c of the second contacting element 10b, 10c, or the second circumference 11b, 11c is larger than the first circumference 11a. This facilitates an arrangement in which the first contacting element 10a at least partly encloses the second contacting element 10b, 10c, or the second contacting element 10b, 10c at least partly encloses the first contacting element 10a.

Particularly advantageously, the first contacting element 10a and the second contacting element 10b, 10c have the cross-sectional shape of the electrode winding 5. As a result, the first contacting element 10a and the second contacting element 10b, 10c cover the contact surface 6a, 6b completely without projecting beyond the circumference of the electrode winding 5. This enables a particularly compact arrangement of the current collector 10 in the battery 1. In FIG. 2, the first contacting element 10a, the second contacting element 10b and the further second contacting element 10c are round, since they are designed to contact a round contact surface of a round electrode winding 5. Alternatively, the first contacting element 10a, the second contacting element 10b and the further second contacting element 10c can also have an ellipsoidal or any other shape.

Preferably, the first contacting element 10a and the second contacting element 10b, 10c are arranged concentrically. This enables an axially symmetrical displacement of the first contacting element 10a and the second contacting element 10b, 10c with respect to one another. Since the electrode windings 5 as are used in round cells or prismatic cells, for example, are axially symmetrical, a concentric arrangement of the first contacting element 10a and the second contacting element 10b, 10c enables particularly good electrical contact between the current collector 10 and the electrode lugs 5a, 5b of the electrode winding 5.

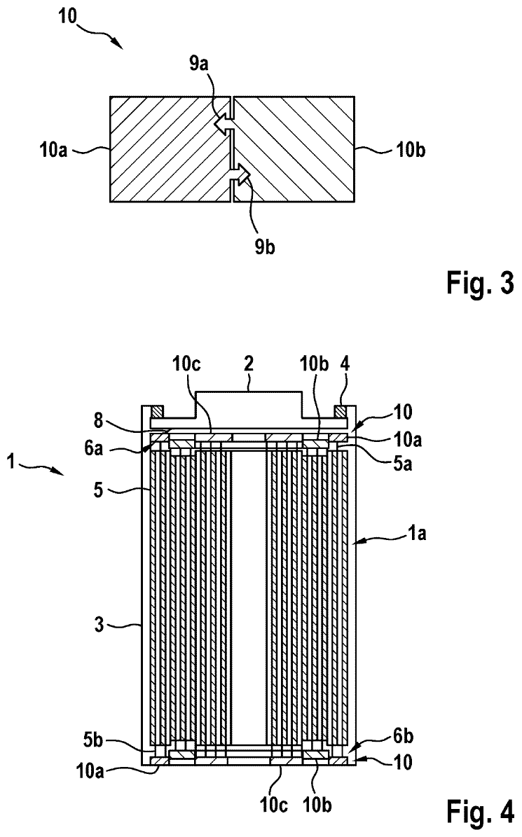

FIG. 3 shows a schematic illustration of a cross section of a current collector 10 according to a second exemplary embodiment of the present disclosure.

In this exemplary embodiment, the first contacting element 10a and the second contacting element 10b, 10c are arranged beside one another. The side-by-side arrangement makes it possible for the first contacting element 10a and the second contacting element 10b, 10c to have an identical shape. Thus, the production complexity and the production outlay of the current collector 10 can be reduced. Here, a force-fitting connection between the first contacting element 10a and the second contacting element 10b, 10c can further be implemented, with the aforementioned advantages.

Preferably, the first contacting element 10a is guided in at least one second groove 9b of the second contacting element 10b and/or the second contacting element 10b is guided in at least one first groove 9a of the first contacting element 10a. By the guidance, a direction of the relative movement of the first contacting element 10a with respect to the second contacting element 10b is predefined. In addition, a force-fitting connection can be implemented via the first groove 9a and/or the second groove 9b.

For example, the first groove 9a and/or the second groove 9b are configured as an undercut. This gives the first groove 9a and/or the second groove 9b the property of preventing a relative movement between the first contacting element 10a and the second contacting element 10b in a different direction than a longitudinal direction of the first groove 9a and/or the second groove 9b. This facilitates the handling of the current collector 10 without reducing the capability of adapting the current collector 10 to the curvature of the contact surface 6a, 6b.

Advantageously, any desired combination of the arrangement of the first contacting element 10a and the second contacting element 10b and the further second contacting elements 10c is possible. This permits better adaptation to more complex curvatures of the contact surface 6a, 6b. In particular, a plurality of second contacting elements 10b, 10c can be arranged beside one another and at least partly enclosed by the first contacting element 10a.

Advantageously, the first contacting element 10a and the second contacting element 10b, 10c are displaceable with respect to one another and adaptable to the contact surface 6a, 6b by pressing onto the contact surface 6a, 6b. Accordingly, it is possible to dispense with scanning the contact surface 6a, 6b and presetting the displacement of the first contact element 10a with respect to the second contact element 10b, 10c. This property of the first contacting element 10a and the second contacting element 10b, 10c is achieved by an appropriately set force-fitting connection. In that, the force needed to overcome the force-fitting connection lies below a force and/or corresponds to this force which the electrode lugs 5a, 5b withstand without breaking off.

FIG. 4 shows a schematic illustration of a battery 1 having a current collector 10 according to the exemplary embodiment of the present disclosure. The battery 1 further comprises a battery element 1a having an electrode winding 5. Electrode lugs 5a, 5b project out of the electrode winding 5 and form an end-face contact surface 6a, 6b of the electrode winding 5. The battery element 1a comprises a current collector 10 according to a previous exemplary embodiment, wherein the first contacting element 10a of the current collector 10 and the second contacting element 10b, 10c of the current collector 10 are adapted to the contact surface 6a, 6b and are at least partly electrically connected to the contact surface 6a, 6b. Such a battery element 1a has a better contact between the current collector 10 and the electrode winding 5 and enables simpler production.

As can be seen in FIG. 4, the second contacting element 10b, 10c of the current collector 10 is displaced with respect to the first contacting element 10a and the further second contacting element 10b, 10c. As a result, the second contacting element 10b, 10c is capable of also contacting the electrode lugs 5a, 5b which are displaced with respect to the surrounding electrode lugs 5a, 5b. It can likewise be seen that, with an increasing number of further second contacting elements 10b, 10c, the curvature of the contact surface 6a, 6b can be sensed better.

Preferably, the battery element 1a has an integral connection, in particular a welded connection, between the first contacting element 10a and/or the second contacting element 10b, 10c and the contact surface 6a, 6b. An integral connection enables a particularly low electrical resistance between the electrode lugs 5a, 5b and the first contacting element 10a and the second contacting element 10b. A welded connection, in particular a welded connection created by laser welding, needs no direct mechanical intervention in the battery 1 and accelerates the production of the battery 1.

Particularly preferably, the first contacting element 10a and the second contacting element 10b are at least partly fastened to one another by the integral connection. Here, the integral connection between the first contacting element 10a and the second contacting element 10b, 10c opposes a greater force to a displacement between the first contacting element 10a and the second contacting element 10b, 10c than the force-fitting connection. After an integral connection, a simple displacement is no longer readily possible.

However, this is desired, since the integral connection between the first contacting element 10a and the second contacting element 10b, 10c is made only after the first contacting element 10a and the second contacting element 10b, 10c have been adapted to the contact surface 6a, 6b, and an unintended displacement between the first contacting element 10a and the second contacting element 10b, 10c is prevented. Thus, an integral connection between the first contacting element 10a and the second contacting element 10b, 10c ensures an electrical connection between the contact surface 6a, 6b and the first contacting element 10a and the second contacting element 10b, 10c even under the action of higher external forces on the battery 1, as occur, for example, in the event of impacts.

### LIST OF DESIGNATIONS

1 Battery
1a Battery element
2 Positive terminal of the battery
3 Negative terminal of the battery
4 Seal
5 Electrode winding
5a Electrode lugs on the anode
5b Electrode lugs on the cathode
6a Anode-side contact surface
6b Cathode-side contact surface
7 Current collector according to the prior art
8 Connecting spring
9a First groove
9b Second groove
10 Current collector
10a First contacting element
10b Second contacting element
10c Further second contacting element
11a First circumference of the first contacting element
11b Second circumference of the second contacting element
11c Further second circumference of the further second contacting element

1-11. (canceled)

12. A current collector for a battery having an electrode winding, wherein electrode lugs project from the electrode winding and form an end-face contact surface of the electrode winding, the current collector comprising:
a first contacting element and at least one second contacting element, wherein the first contacting element and the second contacting element are electrically conductive, are electrically connected to one another, and are configured to:
be displaceable with respect to one another so as to be adapted to a shape of the end-face contact surface; and
be electrically connected to the end-face contact surface.

13. The current collector according to claim 12,
wherein the first contacting element and the at least one second contacting element are connected to one another via a force-fitting connection, wherein the force-fitting connection applies at least a predefined clamping force between the first contacting element and the at least one second contacting element.

14. The current collector according to claim 12,
wherein the first contacting element at least partly encloses the at least one second contacting element, or the at least one second contacting element at least partly encloses the first contacting element.

15. The current collector according to claim 14,
wherein the first contacting element and the at least one second contacting element have a same shape,
wherein a first circumference of the first contacting element is larger than a second circumference of the at least one second contacting element, or the second circumference is larger than the first circumference.

16. The current collector according to claim 12,
wherein the first contacting element and the at least one second contacting element are arranged concentrically.

17. The current collector according to claim 12,
wherein the first contacting element and the at least one second contacting element are arranged beside one another.

18. The current collector according to claim 17,
wherein the first contacting element is guided in at least a second groove of the at least one second contacting element, and/or the at least one second contacting element is guided in at least a first groove of the first contacting element.

19. The current collector according to claim 12,
wherein the first contacting element and the at least one second contacting element are configured to be displaceable with respect to one another and adaptable to the end-face contact surface by pressing onto the end-face contact surface.

20. A battery element comprising:
an electrode winding, wherein electrode lugs project out of the electrode winding and form an end-face contact surface of the electrode winding; and
the current collector according to claim 12, wherein the first contacting element of the current collector and the at least one second contacting element of the current collector are adapted to the end-face contact surface and are at least partly electrically connected to the end-face contact surface.

21. The battery element according to claim 20, comprising:
an integral connection comprising a welded connection between the first contacting element and/or the at least one second contacting element and the end-face contact surface.

22. The battery element according to claim 21,
wherein the first contacting element and the at least one second contacting element are at least partly fastened to one another by the integral connection.
